(19) United States
(12) Patent Application Publication
(10) Pub. No.: US 2023/0021480 A1
(43) Pub. Date: Jan. 26, 2023

(54) Home Care Compositions

(71) Applicant: Colgate-Palmolive Company, New York, NY (US)

(72) Inventors: Maria Antonieta VALDES VERGARA, Mexico City (MX); Carlos MUNOZ CARRILLO, Estado de Mexico (MX); Jose Manuel HOFFMANN ALVAREZ, Mexico City (MX); Henry PENA, Edo México (MX)

(73) Assignee: Colgate-Palmolive Company, New York, NY (US)

(21) Appl. No.: 17/784,881

(22) PCT Filed: Dec. 4, 2020
(86) PCT No.: PCT/US2020/070852

§ 371 Date: Jun. 13, 2022

Related U.S. Application Data
(60) Provisional application No. 62/950,668, filed on Dec. 19, 2019.

(51) Int. Cl. C11D 1/66; C11D 11/00; C11D 17/00; C11D 3/43; C11D 3/20

(52) U.S. Cl. CPC C11D 1/662; C11D 11/0023; C11D 17/0043; C11D 3/43; C11D 3/2044; C11D 3/2086; C11D 3/2065

(57) ABSTRACT

Described herein are hard-surface cleaning compositions comprising: an alkyl polyglycoside; an organic solvent comprising a diol having the formula: CₙH₂ₙ(OH)₂, wherein n=3 to 10 and mixtures thereof; an alpha hydroxy acid; and a humectant. Methods of making and using these hard-surface cleaning compositions are also described herein.

### BACKGROUND

The use of bidens extract to reduce signs of skin aging is disclosed in International Patent Publication No. WO/2015/167545. Compositions for reducing skin aging are disclosed therein. The compositions can be topically applied to a skin region to reduce or prevent skin wrinkles, fine lines, thinning skin, sagging skin, skin dryness, and skin itchiness.

Botanical antimicrobial compositions are disclosed in U.S. Patent Application Publication No. 2015/0265666. Disclosed herein are antimicrobial compositions comprising mixtures of botanical extracts, synthetic antimicrobial agents and essential oils which do not rely solely upon alcohol to produce their antimicrobial effects.

A cleanser composition is disclosed in Korean Patent No. 10-1973478. According to an embodiment of the disclosed invention, a cleansing agent composition comprises: 1-5 wt. % of a gelling agent; 15-50 wt. % of a surfactant; 0.1-0.6 wt. % of a pH control agent; 7-40 wt. % of a moisturizer; 0.01-1 wt. % of a curing agent; and the remaining amount of purified water. The gelling agent includes one selected from carrageenan and tamarindus indica seed gum, the surfactant includes one or more selected from sodium cocoyl glutamate, coco-betaine, cocamidopropyl betaine, TEA-cocoyl glutamate, sodium laureth sulfate, sodium lauryl sulfate, decyl glucoside, sodium lauroyl methyl isethionate, and lauryl glucoside. The pH control agent includes one or more selected from glycolic acid, disodium phosphate, lactic acid, malic acid, succinic acid, citric acid, acetic acid, ascorbic acid, azelaic acid, and tartaric acid. Therefore, the cleansing agent composition can provide excellent surface hardness or prevent syneresis by forming one selected from carrageenan and tamarindus indica seed gum into a gelling agent.

Cleaning and disinfecting preparations comprising a polyoxyalkylene carboxylate are disclosed in European Patent Publication EP 3 536 383. That publication relates to cleaning and care compositions containing at least one polyoxyalkylene carboxylate and their use as cosmetic or medical cleansing and care products. The polyoxyalkylene carboxylates are based on fatty acids from vegetable oils and have an exceptionally high proportion of long-chain (≥C17), predominantly unsaturated hydrocarbon chains.

Nowadays understanding properly how to develop a new formula categorized as ECO/NATURAL is essential, as consequence that trends show that this market will grow up to 80% in the next 10 years, making important having clear concepts about it, in order to find accurate and practical solutions for potential obstacles.

Unfortunately, “Eco/Natural Products” use to have a low performance as a consequence of its milder effects. By the other way, this formula provides a true eco cleaner with high performance using a few raw materials for an easy manufacturing process.

Although many advances in the art of formulating a cleaners using natural and ecologically friendly ingredients have been made, a commercially viable naturally derived cleaners with multiple benefits remains elusive.

### BRIEF SUMMARY

In some embodiments, the present invention provides naturally derived cleaner compositions with multipurpose benefits. In some embodiments, the present invention is directed to an aqueous cleaning composition comprising an alkyl polygylcoside; an organic solvent comprising a diol; an alpha hydroxy acid; and a humectant. In some embodiments, the alkyl polyglycoside comprises a blend of a C₈₋₁₀ alkyl polyglycoside and a C₁₀₋₁₆ alkyl polyglycoside. In some embodiments, the diol is of the formula: CₙH₂ₙ(OH)₂, wherein n=3 to 10; and mixtures thereof. In some embodiments, the weight ratio of the C₈₋₁₀ alkyl polyglycoside to C₁₀₋₁₆ alkyl polyglycoside is from about 7:3 to about 6:4.

The present invention is also directed to a cleaner comprising mostly or wholly of such aqueous cleaning composition. Such a cleaner is ecologically friendly. It is composed of natural or derived natural products that replace synthetic or harmful substances. The composition comprises a naturally derived surfactant, a self-preserving ingredient, a wetting agent and a gentle fragrance.

There are several advantages of the aqueous cleaning composition and the cleaner based thereon. Such advantages include the composition is comprised entirely of ecologically friendly ingredients; the composition comprises at least 99% natural derived content; the composition provides either just as good or better cleaning performance than the commercially available cleaners; the composition has no opacity or very little opacity; the composition comprises an ecologically friendly a diol and a humectant; the composition comprises an alpha-hydroxy acid which acts as a natural disinfectant, preservative, soap scum remover, and limescale remover; alpha-hydroxy acid helps to avoid toxic preservatives commonly used, the cleaning composition performs as an effective on soap scum & limescale remover, degreaser, exhibits fewer residues, provided consistent foam, and may be mild on user's hands; the composition comprises a greater than 99% Natural Derived Content; the ingredients of the composition are high biodegradable; the ingredients are non-toxic; none of the ingredients are unsafe ingredients; the aqueous cleaning composition comprises low number of ingredients, which allows for a cheaper and easier manufacturing process; and the aqueous cleaning composition has little or no opacity.

Alkyl polyglycosides are a class of non-ionic surfactants which are suitable for use in a variety of cosmetic, household, and industrial applications. Alkyl polyglycosides are biodegradable and plant-derived from sugars and fatty alcohols. Alkyl polyglucoside, an example of alkyl polyglycoside, has the formula

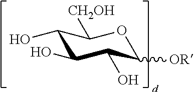

wherein the R′ is an alkyl group, and d is the average number of glucose units per alkyl chain. The variable d is the degree of polymerization.

Because alkyl polyglucosides are 100% naturally derived, they may also be used as a replacement for anionic surfactants in many cleaning applications. This is especially true for use in Eco-Cleaners, or cleaners that are ecologically friendly.

Under one embodiment, the composition of the present invention comprises C₈₋₁₈ alkyl polyglucoside. Under one embodiment, the composition of the present invention comprises C₈₋₁₂ alkyl polyglucoside. Under one embodiment, the composition of the present invention comprises C₁₀ alkyl polyglucoside.

A diol, as used herein, is a chemical compound containing two hydroxyl groups. An example of a diol is an aliphatic diol called a glycol. Examples of diols include ethylene glycol, 1,3-propanediol, 1,2-propanediol, and 1,4-butanediol.

Alpha hydroxy acids, or alpha-hydroxy acids, or α-hydroxy acids, or AHAs, are a class of chemical compounds that consist of a carboxylic acid substituted with a hydroxyl group on the adjacent carbon. Alpha hydroxy acids may be naturally occurring or synthetic.

The use of alpha hydroxy acid in the cleaning composition of the present invention is both ecologically friendly and friendly to the health of the user. It is a natural acid often found in foods.

Under one embodiment, the alpha hydroxy acid is selected from the group consisting of citric acid, glycolic acid, lactic acid, malic acid, tartaric acid, and mixtures thereof.

Under one embodiment, the composition of the present invention comprises an alpha hydroxy acid has the formula R—CH(OH)—COOH, wherein R is H or a C₁₋₈ hydrocarbyl group. Examples of alpha hydroxy acid have the formula R—CH(OH)—COOH, wherein R is H or a C₁₋₈ hydrocarbyl group, include glycolic acid, lactic acid, mandelic acid, and mixtures thereof.

A humectant is a hygroscopic substance used to keep things moist. It is often a molecule with several hydrophilic groups, most often hydroxyl groups; however, amines and carboxyl groups, sometimes esterified, can be encountered as well (its affinity to form hydrogen bonds with molecules of water is the crucial trait). Exemplary humectants that can be used according to the invention include glycerin, glycol, and sugars.

The present invention is also directed to a cleaner comprising the aqueous cleaning composition. Under one embodiment, the cleaner consists of the aqueous cleaning composition, meaning that the cleaner contains only five ingredients: alkyl polyglycoside, an organic solvent comprising a diol, an alpha-hydroxy acid, a humectant, and water. Under one embodiment, the cleaner comprises the aqueous cleaning composition, and further contain additional ingredients. Under one embodiment, the cleaner comprises more than 90 wt. % of the aqueous cleaning composition.

The additional ingredients may be selected from the group consisting of surfactant, chelating agent, alkaline ingredient, fragrance, salt, emulsifier, degreasing agent, essential oil, colorant, solvent, corrosion inhibitor.

Under one embodiment, the cleaner consists of six ingredients: alkyl polyglycoside, an organic solvent comprising a diol, an alpha-hydroxy acid, a humectant, water, and fragrance.

Examples of fragrances which may be used include lavender oil, eau de lavender, orange & ginger fragrance, coconut & citrus fragrance, apricot oil, bay oil, calendula oil, Aztec marigold oil, lemongrass oil, rose oil, lime oil, white grapefruit oil, and lavender vanilla fragrance.

The present invention is also directed to the aqueous cleaning composition, wherein the cleaner is a floor cleaner, a multipurpose cleaner, a hard surface cleaner, an all-purpose cleaner, or a spray cleaner.

The present invention is also directed to a method of cleaning a substrate comprising administering an effective amount of the cleaner to the substrate. The substrate is a surface in need of cleaning, such as the surface of a floor, a countertop, bathroom surfaces, surface of appliances metal parts, building façade, toilet bowl surfaces, glass surfaces, and like.

The present invention is exemplified by at least eighteen aspects.

In the first aspect, the invention relates to an aqueous cleaning composition comprising an alkyl polyglycoside; an organic solvent comprising a diol having the formula: CₙH₂ₙ(OH)₂, wherein n=3 to 10 and mixtures thereof; an alpha hydroxy acid; and a humectant. In some embodiments, the alkyl polyglycoside comprises a blend of a C₈₋₁₀ alkyl polyglycoside and a C₁₀₋₁₆ alkyl polyglycoside. In some embodiments, the diol is of the formula: CₙH₂ₙ(OH)₂, wherein n=3 to 10; and mixtures thereof. In some embodiments, the weight ratio of the C₈₋₁₀ alkyl polyglycoside to C₁₀₋₁₆ alkyl polyglycoside is from about 7:3 to about 6:4.

In the second aspect, the invention relates to an aqueous cleaning composition comprising from about 1 wt. % to about 10 wt. % of a blend of a C₈₋₁₀ alkyl polyglycoside and a C₁₀₋₁₆ alkyl polyglycoside; an organic solvent comprising a diol having the formula: CₙH₂ₙ(OH)₂, wherein n=3 to 10 and mixtures thereof; an alpha hydroxy acid; and a humectant.

In the third aspect, the invention relates to an aqueous cleaning composition comprising from about 2 wt. % to about 6 wt. % of a blend of a C₈₋₁₀ alkyl polyglycoside and a C₁₀₋₁₆ alkyl polyglycoside; an organic solvent comprising a diol having the formula: CₙH₂ₙ(OH)₂, wherein n=3 to 10 and mixtures thereof; an alpha hydroxy acid; and a humectant.

In the fourth aspect, the invention relates to an aqueous cleaning composition comprising a blend of a C₈₋₁₀ alkyl polyglycoside and a C₁₀₋₁₆ alkyl polyglycoside; an organic solvent comprising a diol having the formula: CₙH₂ₙ(OH)₂, wherein n=3 to 10 and mixtures thereof; an alpha hydroxy acid; and a humectant.

In the fifth aspect, the invention relates to an aqueous cleaning composition comprising a C₈₋₁₀ alkyl polyglycoside; an organic solvent comprising a diol having the formula: CₙH₂ₙ(OH)₂, wherein n=3 to 10 and mixtures thereof; an alpha hydroxy acid; and a humectant.

In the sixth aspect, the invention relates to an aqueous cleaning composition comprising a C₁₀₋₁₆ alkyl polyglucoside; an organic solvent comprising a diol having the formula: CₙH₂ₙ(OH)₂, wherein n=3 to 10 and mixtures thereof; an alpha hydroxy acid; and a humectant.

In the seventh aspect, the invention relates to an aqueous cleaning composition comprising a blend of a C₈₋₁₀ alkyl polyglycoside and a C₁₀₋₁₆ alkyl polyglycoside; from about 0.5 wt. % to about 10 wt. % of an organic solvent comprising a diol having the formula: CₙH₂ₙ(OH)₂, wherein n=3 to 10 and mixtures thereof; an alpha hydroxy acid; and a humectant.

In the eighth aspect, the invention relates to an aqueous cleaning composition comprising a blend of a C₈₋₁₀ alkyl polyglycoside and a C₁₀₋₁₆ alkyl polyglycoside; from about 1 wt. % to about 4 wt. % of an organic solvent comprising a diol having the formula: CₙH₂ₙ(OH)₂, wherein n=3 to 10 and mixtures thereof; an alpha hydroxy acid, and a humectant.

In the ninth aspect, the invention relates to an aqueous cleaning composition comprising a blend of a C₈₋₁₀ alkyl polyglycoside and a C₁₀₋₁₆ alkyl polyglycoside; an organic solvent comprising a diol having the formula: CₙH₂ₙ(OH)₂, wherein n=3 to 10 and mixtures thereof, and wherein the diol is selected from the group consisting of ethanediol, propanediol, butanediol, and mixtures thereof; an alpha hydroxy acid; and a humectant.

In the tenth aspect, the invention relates to an aqueous cleaning composition comprising a blend of a C₈₋₁₀ alkyl polyglycoside and a C₁₀₋₁₆ alkyl polyglycoside; 1,3-propanediol; an alpha hydroxy acid; and a humectant.

In the eleventh aspect, the invention relates to an aqueous cleaning composition comprising a blend of a C₈₋₁₀ alkyl polyglycoside and a C₁₀₋₁₆ alkyl polyglycoside; an organic solvent comprising a diol having the formula: CₙH₂ₙ(OH)₂, wherein n=3 to 10 and mixtures thereof; an alpha hydroxy acid selected from the group consisting of citric acid, glycolic acid, lactic acid, malic acid, tartaric acid, and mixtures thereof; and a humectant.

In the twelfth aspect, the invention relates to an aqueous cleaning composition comprising a blend of a C₈₋₁₀ alkyl polyglycoside and a C₁₀₋₁₆ alkyl polyglycoside; an organic solvent comprising a diol having the formula: CₙH₂ₙ(OH)₂, wherein n=3 to 10 and mixtures thereof; an alpha hydroxy acid of the formula R—CH(OH)—COOH, wherein R is H or a C₁₋₈ hydrocarbyl group; and a humectant.

In the thirteenth aspect, the invention relates to an aqueous cleaning composition comprising a blend of a C₈₋₁₀ alkyl polyglycoside and a C₁₀₋₁₆ alkyl polyglycoside; an organic solvent comprising a diol having the formula: CₙH₂ₙ(OH)₂, wherein n=3 to 10 and mixtures thereof; an alpha hydroxy acid selected from the group consisting of glycolic acid, lactic acid, and mandelic acid, and mixtures thereof; and a humectant.

In the fourteenth aspect, the invention relates to an aqueous cleaning composition comprising a blend of a C₈₋₁₀ alkyl polyglycoside and a C₁₀₋₁₆ alkyl polyglycoside; an organic solvent comprising a diol having the formula: CₙH₂ₙ(OH)₂, wherein n=3 to 10 and mixtures thereof; from about 0.5 wt. % to about 10 wt. % of an alpha hydroxy acid; and a humectant.

In the fifteenth aspect, the invention relates to an aqueous cleaning composition comprising a blend of a C₈₋₁₀ alkyl polyglycoside and a C₁₀₋₁₆ alkyl polyglycoside; an organic solvent comprising a diol having the formula: CₙH₂ₙ(OH)₂, wherein n=3 to 10 and mixtures thereof; an alpha hydroxy acid; and a humectant selected from the group consisting of glycerin, polyethylene glycol, propylene glycol, and mixtures thereof.

In the sixteenth aspect, the invention relates to a cleaner comprising more than 90 wt. % of the aqueous cleaning composition comprising a blend of a C₈₋₁₀ alkyl polyglycoside and a C₁₀₋₁₆ alkyl polyglycoside; an organic solvent comprising a diol having the formula: CₙH₂ₙ(OH)₂, wherein n=3 to 10 and mixtures thereof; an alpha hydroxy acid; and a humectant.

In the seventeenth aspect, the invention relates to cleaner comprising more than 90 wt. % of the aqueous cleaning composition comprising a blend of a C₈₋₁₀ alkyl polyglycoside and a C₁₀₋₁₆ alkyl polyglycoside; an organic solvent comprising a diol having the formula: CₙH₂ₙ(OH)₂, wherein n=3 to 10 and mixtures thereof; an alpha hydroxy acid, and a humectant; and a fragrance.

In the eighteenth aspect, the invention relates to a method of cleaning a substrate comprising administering an effective amount of the cleaner of comprising more than 90 wt. % of the aqueous cleaning composition comprising a blend of a C₈₋₁₀ alkyl polyglycoside and a C₁₀₋₁₆ alkyl polyglycoside; an organic solvent comprising a diol having the formula: CₙH₂ₙ(OH)₂, wherein n=3 to 10 and mixtures thereof; an alpha hydroxy acid; and a humectant; to the substrate.

### DETAILED DESCRIPTION

For illustrative purposes, the principles of the present invention are described by referencing various exemplary embodiments thereof. Although certain embodiments of the invention are specifically described herein, one of ordinary skill in the art will readily recognize that the same principles are equally applicable to, and can be employed in other apparatuses and methods. Before explaining the disclosed embodiments of the present invention in detail, it is to be understood that the invention is not limited in its application to the details of any particular embodiment shown. The terminology used herein is for the purpose of description and not of limitation.

As used herein and in the appended claims, the singular forms “a”, “an”, and “the” include plural references unless the context dictates otherwise. The singular form of any class of the ingredients refers not only to one chemical species within that class, but also to a mixture of those chemical species; for example, the phrase “alcohol alkoxylate” in the singular form, may refer to a mixture of compounds each of which is also considered an alcohol alkoxylate. The terms “a” (or “an”), “one or more” and “at least one” may be used interchangeably herein. The terms “comprising”, “including”, and “having” may be used interchangeably. The term “include” should be interpreted as “include, but are not limited to”. The term “including” should be interpreted as “including, but are not limited to”.

The abbreviations and symbols as used herein, unless indicated otherwise, take their ordinary meaning. The abbreviation “wt. %” means percent by weight. The symbols “g” and “m” mean gram and meter, respectively.

The term “Q.S.” means quantum satis. In the context of this disclosure, it means a sufficient amount of water that the weight percent of all recited ingredients add up to 100 wt. %.

When referring to chemical structures, and names, the symbols “C”, “H”, and “O” mean carbon, hydrogen, and oxygen, respectively. The symbols “-” and “=” mean a single bond, and a double bond, respectively. The term “APG” refers to alkyl polyglucoside.

The term “about” when referring to a number means any number within a range of 10% of the number. For example, the phrase “about 6 wt. %” refers to a number between and including 5.400 wt. % and 6.600 wt. %.

As used throughout, ranges are used as shorthand for describing each and every value that is within the range. Any value within the range can be selected as the terminus of the range.

For readability purposes, the chemical functional groups may be in their adjective form; for each of the adjective, the word “group” is assumed. For example, the adjective “alkyl” without any nouns thereafter, may be read as “an alkyl group”.

The term “mixture” is to be interpreted broadly. It refers to a mixture of ingredients. If a mixture is a liquid, a mixture may be a solution, an emulsion, a dispersion, a mixture displaying the Tyndall effect, or any other homogeneous mixture. Under one embodiment, the mixture is shelf-stable. When referring to a list of ingredients, unless specifically indicated otherwise, the term “mixture” refers to a mixture of the aforementioned ingredients with each other, a mixture of any of aforementioned ingredients with other ingredients that are not aforementioned, and to a mixture of several aforementioned ingredients with other ingredients that are not aforementioned. For example, the term “mixture” in the phrase “the diol is selected from the group consisting of ethanediol, propanediol, butanediol, and mixture thereof” refers to any of the following: (a) a mixture of ethanediol and propanediol; (b) a mixture of ethanediol and butanediol; (c) a mixture of propanediol and butanediol; (d) mixture of ethanediol, propanediol and butanediol; (e) a mixture of ethanediol and any other diol or diols; (f) a mixture of propanediol and any other diol or diols; (g) a mixture of butanediol and any other diol or diols; (h) a mixture of ethanediol, propanediol, and any other diol or diols; (i) a mixture of ethanediol, butanediol, and any other diol or diols; (j) a mixture of propanediol, butanediol, and any other diol or diols; and (k) mixture of ethanediol, propanediol, butanediol, and any other diol or diols.

Any member in a list of species that are used to exemplify or define a genus may be mutually different from, or overlapping with, or a subset of, or equivalent to, or nearly the same as, or identical to, any other member of the list of species. Further, unless explicitly stated (such as when reciting a Markush group), the list of species that define or exemplify the genus is open, and it is given that other species may exist that define or exemplify the genus just as well as, or better than, any other species listed.

All references cited herein are hereby incorporated by reference in their entireties. In the event of a conflict in a definition in the present disclosure and that of a cited reference, the present disclosure controls.

In some embodiments, the present invention provides naturally derived cleaner compositions with multipurpose benefits. In some embodiments, the present invention is directed to an aqueous cleaning composition comprising an alkyl polygylcoside; an organic solvent comprising a diol; an alpha hydroxy acid; and a humectant. In some embodiments, the alkyl polyglycoside comprises a blend of a C₈₋₁₀ alkyl polyglycoside and a C₁₀₋₁₆ alkyl polyglycoside. In some embodiments, the diol is of the formula: CₙH₂ₙ(OH)₂, wherein n=3 to 10; and mixtures thereof. In some embodiments, the weight ratio of the C₈₋₁₀ alkyl polyglycoside to C₁₀₋₁₆ alkyl polyglycoside is from about 7:3 to about 6:4.

The present invention is also directed to a cleaner comprising mostly or wholly of such aqueous cleaning composition. Such a cleaner is ecologically friendly. It is composed of natural products that replace synthetic or harmful substances. The composition comprises a naturally derived surfactant, a self-preserving ingredient, a wetting agent and a gentle fragrance.

Although many ecologically friendly and natural products have traditionally had poor performance compared to synthetic substances, the composition of the present invention is a true eco cleaner with high performance using few raw materials. The low number of raw materials results in an easy manufacturing process.

The aqueous cleaning composition of the present invention has little or no opacity and is dye-free.

There are several advantages of the aqueous cleaning composition and the cleaner based thereon.

One of the advantages of the aqueous cleaning composition is that the composition is comprised entirely of ecologically friendly ingredients.

One of the advantages of the aqueous cleaning composition is that the composition comprises at least 99% natural derived content. Natural derived content, or natural derived ingredients, are those ingredients whose starting material originates from plants, minerals, microbes or animals that may be adapted to provide performance.

One of the advantages of the aqueous cleaning composition is that the composition provides either just as good or better cleaning performance than the commercially available cleaners.

Another advantage of the aqueous cleaning composition is that the composition has no opacity or very little opacity, compared to other cleaning compositions. This is considered advantageous by the purchaser or end-user of the product.

Yet another advantage of the aqueous cleaning composition is that the composition comprises an ecologically friendly a diol and a humectant. Both have cosmetic moisturizing effects that help the product mildness.

Still another advantage of the aqueous cleaning composition is that the composition comprises an alpha-hydroxy acid, which acts as a natural disinfectant, preservative, soap scum remover, and limescale remover. Alpha-hydroxy acid helps to avoid toxic preservatives commonly used, such as isothiazolinones and phenoxyethanol, which are not appropriate for the ecologically-friendly cleaner market.

A further advantage of the aqueous cleaning composition is that it performs as an effective on soap scum & limescale remover, degreaser, exhibits fewer residues, provided consistent foam, and may be mild on user's hands.

One advantage of the aqueous cleaning composition found includes a REAL congruent ECO formula.

One advantage of the aqueous cleaning composition is that the composition comprises a greater than 99% Natural Derived Content.

One advantage of the aqueous cleaning composition is that the ingredients of the composition are high biodegradable.

One advantage of the aqueous cleaning composition is that the ingredients are non-toxic.

One advantage of the aqueous cleaning composition is that none of the ingredients are unsafe ingredients.

One advantage of the aqueous cleaning composition is the low number of ingredients, which allows for a cheaper and easier manufacturing process.

One advantage of the aqueous cleaning composition of the present invention is that the aqueous cleaning composition has little or no opacity. Empirical marketing evidence suggests that end users who are concerned about using eco-friendly products prefer to use products with little or no opacity.

In certain embodiments, the present invention is directed to an aqueous cleaning composition comprising an alkyl polyglycoside, an organic solvent comprising a diol having the formula: CₙH₂ₙ(OH)₂, wherein n=3 to 10 and mixtures thereof, an alpha-hydroxy acid, and a humectant. In some embodiments, the alkyl polyglycoside comprises a blend of a C₈₋₁₀ alkyl polyglycoside and a C₁₀₋₁₆ alkyl polyglycoside.

Alkyl polyglycosides are a class of non-ionic surfactants which are suitable for use in a variety of cosmetic, household, and industrial applications. Alkyl polyglycosides are biodegradable and plant-derived from sugars and fatty alcohols. The raw materials are typically starch and fat, and the final products are typically complex mixtures of compounds with different sugars comprising the hydrophilic end and alkyl groups of variable length comprising the hydrophobic end. When derived from glucose, alkyl polyglycosides are known as alkyl polyglucosides.

Alkyl polyglucoside, an example of alkyl polyglycoside, has the formula

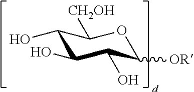

wherein the R′ is an alkyl group, and d is the average number of glucose units per alkyl chain. The variable d is the degree of polymerization.

In the synthesis of glycosides, a polyfunctional sugar component is combined with a nucleophile, such as an alcohol, a carbohydrate or a protein. If a selective reaction with one of the hydroxyl groups of the carbohydrate is required, all other functions have to be protected in a first reaction step. Under one embodiment, enzymatic or microbial procedures, by virtue of their selectivity, replaces complicated chemical protection and deprotection steps where regioselective formation of glycosides is required.

Under one embodiment, the glycosides may be prepared by a method with comprises a reaction of a sugar with acetyl chloride.

Under one embodiment, the glycoside is prepared by Fischer glycosidation, which comprises an acid-catalyzed reaction of glycoses. Fischer glycosidation products are complex, mostly equilibrium mixtures of α/β-anomers and pyranoside/furanoside isomers which also comprise randomly linked glycoside oligomers.

Chemical glycosidation processes may be divided into processes leading to complex oligomer equilibria in acid-catalyzed glycosyl exchange reactions (Fischer glycosidation and reactions in hydrogen fluoride (HF) with unprotected carbohydrate molecules) and kinetically controlled, irreversible, mostly stereospecific substitution reactions on suitably activated carbohydrate substrates. Procedures of the second type may result in the formation of individual species rather than in complex reaction mixtures, especially when combined with protective group techniques. Carbohydrates may be activated at the anomeric carbon by leaving groups, such as halogen atoms, the sulfonium group, or the trichloroacetimidate group, or by base activation before conversion with triflate esters. See, Alkyl Polyglycosides, ed. K. Hill et al., VCH Verlagsgesellschaft mbH, Weinheim, Germany, 1997.

The raw materials for the manufacture of alkyl polyglycosides may be obtained from commercial sources as is known to a person of ordinary skill in the art. Fatty alcohols can be obtained either from petrochemical sources (synthetic fatty alcohols) or from natural, renewable resources, such as fats and oils (natural fatty alcohols). Fatty alcohol blends are used in the alkyl polyglycoside synthesis to build up the hydrophobic part of the molecule. The natural fatty alcohols are obtained after transesterification and fractionation of fats and oils (triglycerides), leading to the corresponding fatty acid methyl esters, and subsequent hydrogenation. Depending on the desired alkyl chain length of the fatty alcohol, the main feedstocks are oils and fats of the following composition: coconut or palm kernel oil for the C₁₂₋₁₄ fatty alcohols, and tallow, palm or rapeseed oil for the C₁₆₋₁₈ fatty alcohols.

The hydrophilic part of the alkyl polyglycoside molecule is derived from carbohydrates. Based on starch from corn, wheat or potatoes, both polymeric and monomeric carbohydrates are suitable as raw materials for the production of alkyl polyglycosides. Polymeric carbohydrates include, for example, starch or glucose syrups with low degradation levels while monomeric carbohydrates can be any of the various forms in which glucose is available, for example water-free glucose, glucose monohydrate (dextrose) or highly degraded glucose syrup. Raw material choice influences not only raw material costs, but also production costs.

Through the polyfunctionality of the carbohydrate partner, the conditions of the acid-catalyzed Fischer reaction yield an oligomer mixture in which on average more than one glycose unit is attached to an alcohol molecule. The average number of glycose units linked to an alcohol group is described as the (average) degree of polymerization (DP). The concentration of the individual oligomers (mono-, di-, tri-, . . . -, glycoside) is largely dependent on the ratio of glucose to alcohol in the reaction mixture. The average degree of polymerization (DP) is an important characteristic with regard to the physical chemistry and applications of alkyl polyglycosides. In an equilibrium distribution, the DP—for a given alkyl chain length—correlates well with basic product properties, such as polarity, solubility, etc.

Because alkyl polyglucosides are 100% naturally derived, they may also be used as a replacement for anionic surfactants in many cleaning applications. This is especially true for use in Eco-Cleaners, or cleaners that are ecologically friendly.

In some embodiments, the compositions of the present invention comprise a C₈₋₁₀ alkyl polyglucoside. Under other embodiments, the compositions of the present invention comprises a C₁₀₋₁₆ alkyl polyglucoside. In certain embodiments, the composition of the present invention comprises a C₈, C₁₀, C₁₂, C₁₄, or C₁₆, alkyl polyglucoside.

The phrase “C₁₀₋₁₆ alkyl” in the phrase “C₁₀₋₁₆ alkyl polyglycoside” or in the phrase “C₁₀₋₁₆ alkyl polyglucoside” means that the polyglycoside or polyglucoside contains an alkyl group with about 10 to about 16 carbons.

Under one embodiment, the phrase “C₈₋₁₈ alkyl” refers to an alkyl group selected from the group consisting of a C₈ alkyl, C₉ alkyl, C₁₀ alkyl, C₁₁ alkyl, C₁₂ alkyl, C₁₃ alkyl, C₁₄ alkyl, C₁₅ alkyl, C₁₆ alkyl, C₁₇ alkyl, C₁₈ alkyl, and mixtures thereof.

Similarly, under one embodiment, the phrase “C₈₋₁₂ alkyl” refers to an alkyl group selected from the group consisting of a C₈ alkyl, C₉ alkyl, C₁₀ alkyl, C₁₁ alkyl, C₁₂ alkyl, and mixtures thereof.

Under one embodiment, the phrase “C₈₋₁₈ alkyl” refers to an alkyl group selected from the group consisting of octyl, nonyl, decyl, undecyl, dodecyl, tridecyl, tetradecyl, pentadecyl, hexadecyl, heptadecyl, and octadecyl.

The phrase “C₁₀ alkyl” means an alkyl group wherein the mean number of carbons is about 10. Under one embodiment, the phrase “C₁₀ alkyl” refers to the decyl group. Under one embodiment, the phrase “C₁₀ alkyl” refers to a mixture of alkyl groups wherein the average number of carbons is about 10. For example, a mixture consisting of 25 wt. % of octyl polyglycoside, 50 wt. % of decyl polyglycoside, and 25 wt. % of dodecyl polyglycoside may be described as a “C₁₀ alkyl polyglycoside”.

Because under some embodiments the alkyl polyglycoside refers to a mixture, the mean number of carbons need not be an integer. Thus, examples of C₈₋₁₈ alkyl also include C_{9.4} alkyl, C_{11.333} alkyl, C_{7×sqrt(3)} alkyl, and like.

In some embodiments, the alkyl polyglycoside may be present in the composition of the present invention at a higher concentration than the level of surfactants in commercially available cleaners. In other embodiments, the aqueous cleaning composition comprises from about 0.5 wt. % to about 10 wt. % of the alkyl polyglycoside. Under some embodiments, the aqueous cleaning composition comprises from about 1 wt. % to about 10 wt. % of an alkyl polyglycoside. Some embodiment provide an aqueous cleaning composition comprising from about 1.5 wt. % to about 10 wt. % of an alkyl polyglycoside.

In some embodiments, the alkyl polyglycoside comprises a blend of a C₈₋₁₀ alkyl polyglycoside and a C₁₀₋₁₆ alkyl polyglycoside. Under some embodiments, the aqueous cleaning composition comprises from about 2 wt. % to about 10 wt. % of a blend of a C₈₋₁₀ alkyl polyglycoside and a C₁₀₋₁₆ alkyl polyglycoside. Under other embodiments, the aqueous cleaning composition comprises from about 4 wt. % to about 10 wt. % of a blend of a C₈₋₁₀ alkyl polyglycoside and a C₁₀₋₁₆ alkyl polyglycoside. Under further embodiments, the aqueous cleaning composition comprises about 6 wt. % to about 10 wt. % of a blend of a C₈₋₁₀ alkyl polyglycoside and a C₁₀₋₁₆ alkyl polyglycoside. Still further embodiments provide an aqueous cleaning composition comprising from about 0.5 wt. % to about 6 wt. % of a blend of a C₈₋₁₀ alkyl polyglycoside and a C₁₀₋₁₆ alkyl polyglycoside. Yet other embodiments provide an aqueous cleaning composition comprising from about 1 wt. % to about 6 wt. % of a blend of a C₈₋₁₀ alkyl polyglycoside and a C₁₀₋₁₆ alkyl polyglycoside. In some embodiments, the aqueous cleaning composition comprises about 1.5 wt. % to about 6 wt. % of a blend of a C₈₋₁₀ alkyl polyglycoside and a C₁₀₋₁₆ alkyl polyglycoside. Under certain embodiments, the aqueous cleaning composition comprises from about 2 wt. % to about 6 wt. % of a blend of a C₈₋₁₀ alkyl polyglycoside and a C₁₀₋₁₆ alkyl polyglycoside. Under some embodiments, the aqueous cleaning composition comprises from about 4 wt. % to about 6 wt. % of a blend of a C₈₋₁₀ alkyl polyglycoside and a C₁₀₋₁₆ alkyl polyglycoside.

Under one embodiment, the aqueous cleaning composition comprises about 0.5 wt. % to about 4 wt. % of a blend of a C₈₋₁₀ alkyl polyglycoside and a C₁₀₋₁₆ alkyl polyglycoside. Under one embodiment, the aqueous cleaning composition comprises about 1 wt. % to about 4 wt. % of a blend of a C₈₋₁₀ alkyl polyglycoside and a C₁₀₋₁₆ alkyl polyglycoside. Under one embodiment, the aqueous cleaning composition comprises about 1.5 wt. % to about 4 wt. % of a blend of a C₈₋₁₀ alkyl polyglycoside and a C₁₀₋₁₆ alkyl polyglycoside. Under one embodiment, the aqueous cleaning composition comprises about 2 wt. % to about 4 wt. % of a blend of a C₈₋₁₀ alkyl polyglycoside and a C₁₀₋₁₆ alkyl polyglycoside. Under one embodiment, the aqueous cleaning composition comprises about 0.5 wt. % to about 2 wt. % of a blend of a C₈₋₁₀ alkyl polyglycoside and a C₁₀₋₁₆ alkyl polyglycoside. Under one embodiment, the aqueous cleaning composition comprises about 1 wt. % to about 2 wt. % of a blend of a C₈₋₁₀ alkyl polyglycoside and a C₁₀₋₁₆ alkyl polyglycoside. Under one embodiment, the aqueous cleaning composition comprises about 1.5 wt. % to about 2 wt. % of a blend of a C₈₋₁₀ alkyl polyglycoside and a C₁₀₋₁₆ alkyl polyglycoside. Under one embodiment, the aqueous cleaning composition comprises about 0.5 wt. % to about 1.5 wt. % of a blend of a C₈₋₁₀ alkyl polyglycoside and a C₁₀₋₁₆ alkyl polyglycoside. Under one embodiment, the aqueous cleaning composition comprises about 1 wt. % to about 1.5 wt. % of a blend of a C₈₋₁₀ alkyl polyglycoside and a C₁₀₋₁₆ alkyl polyglycoside. Under one embodiment, the aqueous cleaning composition comprises about 0.5 wt. % to about 1 wt. % of a blend of a C₈₋₁₀ alkyl polyglycoside and a C₁₀₋₁₆ alkyl polyglycoside.

In some embodiments, the present invention is directed to an aqueous cleaning composition comprising an alkyl polyglucoside; an organic solvent comprising a diol having the formula: CₙH₂ (OH)₂, wherein n=3 to 10 and mixtures thereof, an alpha-hydroxy acid, and a humectant.

A diol, as used herein, is a chemical compound containing two hydroxyl groups. An example of a diol is an aliphatic diol called a glycol. Examples of diols include ethylene glycol, 1,3-propanediol, 1,2-propanediol, and 1,4-butanediol.

Further examples diols include ethylene glycol, 1,2-ethanediol, ethane-1,2-diol, ethylene alcohol, HO—CH₂—CH₂—OH, propylene glycol, propane-1,2-diol, 1,2-propanediol, 1,2-dihydroxypropane, CH₃—CH(OH)—CH₂—OH, 1,3-propanediol, propane-1,3-diol, 1,3-dihydroxypropane, beta propylene glycol, trimethylene glycol, HO—(CH₂)₃—OH, 1,4-butanediol, BD, butane-1,4-diol, and HO—(CH₂)₄—OH, and mixtures thereof.

Under one embodiment, the diol is a small linear alkane comprising up to 6 carbons, substituted with 2 hydroxyl groups. Such diols are exemplified by 1,2-ethanediol, 1,2-propanediol, 1,3-propanediol, 1,2-butanediol, 1,3-butanediol, 1,4-butanediol, 1,2-pentanediol, 1,3-pentanediol, 1,4-pentanediol, 1,5-pentanediol, 1,2-hexanediol, 1,3-hexanediol, 1,4-hexanediol, 1,5-hexanediol, 1,6-hexanediol, and mixtures thereof.

In some embodiments, the organic solvent comprises a diol. In some embodiments, the organic solvent consists essentially of a diol. In some embodiments, the organic solvent is a diol (e.g. 1,3-propanediol).

In some embodiments, the diol is a linear alkane, branched alkane, or cyclic alkane, substituted with two hydroxyl groups. Examples of diols include ethylene glycol, propylene glycol, 1,2-propanediol, 1,6-hexanediol, 1,3-butanediol, 1,4-butanediol, pentylene glycol, neopentyl glycol, trimethylpropanediol, 1,4-cyclohexanedimethanol, 2,2-dimethyl-1,3-propanediol, 2,2,4,4-tetramethyl-1,3-cyclobutanediol, and mixtures thereof.

Under one embodiment, the aqueous cleaning composition comprises about 0.5 wt. % to about 10 wt. % of a diol. Under one embodiment, the aqueous cleaning composition comprises about 1 wt. % to about 10 wt. % of a diol. Under one embodiment, the aqueous cleaning composition comprises about 1.5 wt. % to about 10 wt. % of a diol. Under one embodiment, the aqueous cleaning composition comprises about 2 wt. % to about 10 wt. % of a diol. Under one embodiment, the aqueous cleaning composition comprises about 4 wt. % to about 10 wt. % of a diol. Under one embodiment, the aqueous cleaning composition comprises about 6 wt. % to about 10 wt. % of a diol. Under one embodiment, the aqueous cleaning composition comprises about 0.5 wt. % to about 6 wt. % of a diol. Under one embodiment, the aqueous cleaning composition comprises about 1 wt. % to about 6 wt. % of a diol. Under one embodiment, the aqueous cleaning composition comprises about 1.5 wt. % to about 6 wt. % of a diol. Under one embodiment, the aqueous cleaning composition comprises about 2 wt. % to about 6 wt. % of a diol. Under one embodiment, the aqueous cleaning composition comprises about 4 wt. % to about 6 wt. % of a diol.

Under one embodiment, the aqueous cleaning composition comprises about 0.5 wt. % to about 4 wt. % of a diol. Under one embodiment, the aqueous cleaning composition comprises about 1 wt. % to about 4 wt. % of a diol. Under one embodiment, the aqueous cleaning composition comprises about 1.5 wt. % to about 4 wt. % of a diol. Under one embodiment, the aqueous cleaning composition comprises about 2 wt. % to about 4 wt. % of a diol. Under one embodiment, the aqueous cleaning composition comprises about 0.5 wt. % to about 2 wt. % of a diol. Under one embodiment, the aqueous cleaning composition comprises about 1 wt. % to about 2 wt. % of a diol. Under one embodiment, the aqueous cleaning composition comprises about 1.5 wt. % to about 2 wt. % of a diol. Under one embodiment, the aqueous cleaning composition comprises about 0.5 wt. % to about 1.5 wt. % of a diol. Under one embodiment, the aqueous cleaning composition comprises about 1 wt. % to about 1.5 wt. % of a diol. Under one embodiment, the aqueous cleaning composition comprises about 0.5 wt. % to about 1 wt. % of a diol.

In some embodiments, the present invention is directed to an aqueous cleaning composition comprising an alkyl polyglucoside, an organic solvent comprising a diol, an alpha-hydroxy acid, and a humectant.

Alpha hydroxy acids, or alpha-hydroxy acids, or α-hydroxy acids, or AHAs, are a class of chemical compounds that consist of a carboxylic acid substituted with a hydroxyl group on the adjacent carbon. Alpha hydroxy acids may be naturally occurring or synthetic.

The use of alpha hydroxy acid in the cleaning composition of the present invention is both ecologically friendly and friendly to the health of the user. It is a natural acid often found in foods. It is also used frequently in medial or cosmetic products to treat skin conditions in humans.

Under one embodiment, the alpha hydroxy acid is selected from the group consisting of citric acid, glycolic acid, lactic acid, malic acid, tartaric acid, and mixtures thereof.

Citric acid, or 2-hydroxypropane-1,2,3-tricarboxylic acid, is a weak organic acid that has the chemical formula (HOOC—CH₂)₂C(OH)—COOH. It occurs naturally in citrus fruits. In biochemistry, it is an intermediate in the citric acid cycle, which occurs in the metabolism of all aerobic organisms. Citric acid is an excellent chelating agent, binding metals by making them soluble. Under one embodiment, it is used to remove and discourage the buildup of limescale. It can be used to treat water, which makes it useful in improving the effectiveness of soaps and laundry detergents. By chelating the metals in hard water, it lets these cleaners produce foam and work better without the need for water softening. Under one embodiment, citric acid is the active ingredient in the cleaning composition of the present invention.

Glycolic acid, or hydroacetic acid, or hydroxyacetic acid, is the smallest α-hydroxy acid, and has a chemical formula HO—CH₂—COOH. Glycolic acid is colorless, odorless, and hygroscopic crystalline solid, and highly soluble in water. It is safe to be used in various skin-care products.

Glycolic acid can be synthesized in various ways. Under one embodiment, glycolic acid prepared by a method comprising the step of a catalyzed reaction of formaldehyde with synthesis gas. Under one embodiment, glycolic acid is prepared by a method comprising the steps of reacting chloroacetic acid with sodium hydroxide followed by re-acidification. Under one embodiment, glycolic acid is prepared by a method comprising the step of hydrogenation of oxalic acid, and hydrolysis of the cyanohydrin derived from formaldehyde. Under one embodiment, glycolic acid is isolated from natural sources, such as sugarcane, sugar beets, pineapple, cantaloupe, and unripe grapes. Under one embodiment, glycolic acid is prepared by a method comprising the step of using an enzymatic biochemical process.

Lactic acid is an organic acid. It has a molecular formula CH₃—CH(OH)—COOH. It is white in solid state and it is miscible with water. When dissolved in water, it provides a colorless solution. Production includes both artificial synthesis as well as natural sources. It is used as a synthetic intermediate in many organic synthesis industries and in various biochemical industries.

Under one embodiment, lactic acid is produced by bacterial fermentation of carbohydrates. Exemplary bacteria include Lactobacillus acidophilus, Lactobacillus casei, Lactobacillus delbrueckih, Lactobacillus helvelicus, Lactococcus lactis, and Streptococcus thermophilus. Lactic acid may be produced from almost any carbohydrate source containing C₅ and C₆ sugars. Pure sucrose, glucose from starch, raw sugar, and beet juice are may be used.

Under one embodiment, the lactic acid is produced by a method that comprises the steps of addition of hydrogen cyanide to acetaldehyde and subsequent hydrolysis, forming lactonitrile.

Under one embodiment, the use of lactic acid helps to avoid toxic preservatives commonly used for the “Eco-market” such as Isothiazolinones and Phenoxyethanol.

Malic acid is an alpha hydroxy acid with the molecular formula HO—CH₂—CH(OH)—COOH. It is a dicarboxylic acid that is found in most organisms, contributes to the sour taste of fruits, and is used as a food additive. Under one embodiment, malic acid is produced by a method which comprises the step of double hydration of maleic anhydride.

Tartaric acid is an alpha hydroxy acid with the molecular formula of HOOC—CH(OH)—CH(OH)—COOH. It is a white, crystalline compound that occurs naturally in many fruits, including grapes, bananas, tamarinds, and citrus. Its salt, potassium bitartrate, commonly known as cream of tartar, develops naturally in the process of winemaking.

Under one embodiment, the composition of the present invention comprises an alpha hydroxy acid has the formula R—CH(OH)—COOH, wherein R is H or a C₁₋₈ hydrocarbyl group.

The term “hydrocarbyl” or the phrase “hydrocarbyl group” means a functional group based on the removal of one hydrogen atom from a hydrocarbon. The term “hydrocarbyl” or the phrase “hydrocarbyl group” means a univalent group comprising only carbon and hydrogen atoms. The hydrocarbyl group may be saturated, or it may be unsaturated, or it may be partially saturated. The hydrocarbyl group may be branched, or it may be linear, or it may be alicyclic, or it may be cyclic. Under one embodiment, the alkanoic acid is a fatty acid.

Examples of alpha hydroxy acid have the formula R—CH(OH)—COOH, wherein R is H or a C₁₋₈ hydrocarbyl group, include glycolic acid, lactic acid, mandelic acid, and mixtures thereof.

Mandelic acid is an aromatic alpha hydroxy acid with the molecular formula C₆H₅—CH(OH)—COOH. It is a white crystalline solid that is soluble in water and polar organic solvents. The molecule is chiral; the racemic mixture is known as paramandelic acid.

Under one embodiment, the aqueous cleaning composition comprises about 0.5 wt. % to about 10 wt. % of alpha hydroxy acid. Under one embodiment, the aqueous cleaning composition comprises about 1 wt. % to about 10 wt. % of alpha hydroxy acid. Under one embodiment, the aqueous cleaning composition comprises about 1.5 wt. % to about 10 wt. % of alpha hydroxy acid. Under one embodiment, the aqueous cleaning composition comprises about 2 wt. % to about 10 wt. % of alpha hydroxy acid. Under one embodiment, the aqueous cleaning composition comprises about 4 wt. % to about 10 wt. % of alpha hydroxy acid. Under one embodiment, the aqueous cleaning composition comprises about 6 wt. % to about 10 wt. % of alpha hydroxy acid. Under one embodiment, the aqueous cleaning composition comprises about 0.5 wt. % to about 6 wt. % of alpha hydroxy acid. Under one embodiment, the aqueous cleaning composition comprises about 1 wt. % to about 6 wt. % of alpha hydroxy acid. Under one embodiment, the aqueous cleaning composition comprises about 1.5 wt. % to about 6 wt. % of alpha hydroxy acid. Under one embodiment, the aqueous cleaning composition comprises about 2 wt. % to about 6 wt. % of alpha hydroxy acid. Under one embodiment, the aqueous cleaning composition comprises about 4 wt. % to about 6 wt. % of alpha hydroxy acid.

Under one embodiment, the aqueous cleaning composition comprises about 0.5 wt. % to about 4 wt. % of alpha hydroxy acid. Under one embodiment, the aqueous cleaning composition comprises about 1 wt. % to about 4 wt. % of alpha hydroxy acid. Under one embodiment, the aqueous cleaning composition comprises about 1.5 wt. % to about 4 wt. % of alpha hydroxy acid. Under one embodiment, the aqueous cleaning composition comprises about 2 wt. % to about 4 wt. % of alpha hydroxy acid. Under one embodiment, the aqueous cleaning composition comprises about 0.5 wt. % to about 2 wt. % of alpha hydroxy acid. Under one embodiment, the aqueous cleaning composition comprises about 1 wt. % to about 2 wt. % of alpha hydroxy acid. Under one embodiment, the aqueous cleaning composition comprises about 1.5 wt. % to about 2 wt. % of alpha hydroxy acid. Under one embodiment, the aqueous cleaning composition comprises about 0.5 wt. % to about 1.5 wt. % of alpha hydroxy acid. Under one embodiment, the aqueous cleaning composition comprises about 1 wt. % to about 1.5 wt. % of alpha hydroxy acid. Under one embodiment, the aqueous cleaning composition comprises about 0.5 wt. % to about 1 wt. % of alpha hydroxy acid.

The aqueous cleaning composition of the present invention also comprises a humectant.

A humectant is a hygroscopic substance used to keep things moist. It is often a molecule with several hydrophilic groups, most often hydroxyl groups; however, amines and carboxyl groups, sometimes esterified, can be encountered as well (its affinity to form hydrogen bonds with molecules of water is the crucial trait). A humectant attracts and retains the moisture in the air nearby via absorption, drawing the water vapor into or beneath the organism's or object's surface. This is the opposite use of a hygroscopic material where it is used as a desiccant used to draw moisture away.

Examples of humectant that is used according to the invention includes those substances that exhibit an affinity for water and help enhance the absorption of water onto a substrate. Exemplary humectants that can be used according to the invention include glycerin, glycol, and sugars.

Glycerin, or glycerol, is a simple polyol compound of formula HO—CH₂—CH(OH)—CH₂—OH. It is a colorless, odorless, viscous liquid that is sweet-tasting and non-toxic. It is useful in the composition of the present invention, due to having antimicrobial and antiviral properties. Owing to the presence of three hydroxyl groups, glycerol is miscible with water and is hygroscopic nature.

Examples of glycol includes propylene glycol and oligomers of alkylene glycol such as dipropylene glycol and polyethylene glycol wherein the oligomers remain as a liquid at room temperature.

Examples of sugars include monosaccharides, disaccharides, trisaccharides, and polysaccharides. Monosaccharides have a generic formula (CH₂O)ₓ, wherein x≥3. Monosaccharides can be classified by the number x of carbon atoms they contain: triose (3), tetrose (4), pentose (5), hexose (6), heptose (7), and so on. Examples of hexoses include aldohexoses (e.g., allose, altrose, glucose, mannose, gulose, isose, galactose, and talose) and ketohexoses (e.g., psicose, fructose, sorbose, and tagalose). Additional examples of sugars include sucrose.

The aqueous cleaning composition of the present invention contains the humectant in an amount that cooperates with the other components of the composition.

Under one embodiment, the aqueous cleaning composition comprises about 0.05 wt. % to about 10 wt. % of humectant. Under one embodiment, the aqueous cleaning composition comprises about 0.1 wt. % to about 10 wt. % of humectant. Under one embodiment, the aqueous cleaning composition comprises about 0.3 wt. % to about 10 wt. % of humectant. Under one embodiment, the aqueous cleaning composition comprises about 1 wt. % to about 10 wt. % of humectant. Under one embodiment, the aqueous cleaning composition comprises about 3 wt. % to about 10 wt. % of humectant. Under one embodiment, the aqueous cleaning composition comprises about 0.05 wt. % to about 3 wt. % of humectant. Under one embodiment, the aqueous cleaning composition comprises about 0.1 wt. % to about 3 wt. % of humectant. Under one embodiment, the aqueous cleaning composition comprises about 0.3 wt. % to about 3 wt. % of humectant. Under one embodiment, the aqueous cleaning composition comprises about 1 wt. % to about 3 wt. % of humectant. Under one embodiment, the aqueous cleaning composition comprises about 0.05 wt. % to about 1 wt. % of humectant. Under one embodiment, the aqueous cleaning composition comprises about 0.1 wt. % to about 1 wt. % of humectant. Under one embodiment, the aqueous cleaning composition comprises about 0.3 wt. % to about 1 wt. % of humectant. Under one embodiment, the aqueous cleaning composition comprises about 0.05 wt. % to about 0.3 wt. % of humectant. Under one embodiment, the aqueous cleaning composition comprises about 0.1 wt. % to about 0.3 wt. % of humectant. Under one embodiment, the aqueous cleaning composition comprises about 0.05 wt. % to about 0.1 wt. % of humectant.

In certain embodiments, the present invention is directed to an aqueous cleaning composition comprising an alkyl polyglycoside, an organic solvent comprising a diol, an alpha-hydroxy acid, and a humectant. In addition to the alkyl polyglycoside, an organic solvent comprising a diol, an alpha-hydroxy acid, and a humectant, the aqueous solution may also contain water. Water may be distilled or deionized. The water may be considered a carrier, and most of the aqueous cleaning composition comprises water.

The present invention is also directed to a cleaner comprising the aqueous cleaning composition.

Under some embodiments, the cleaner consists of the aqueous cleaning composition, meaning that the cleaner contains only five ingredients: an alkyl polyglycoside, an organic solvent comprising a diol, an alpha-hydroxy acid, a humectant, and water.

Under other embodiments, the cleaner comprises the aqueous cleaning composition, and further contains additional ingredients.

Under further embodiments, the cleaner comprises more than 90 wt. % of the aqueous cleaning composition. Under some embodiments, the cleaner comprises more than 94 wt. % of the aqueous cleaning composition. Under other embodiments, the cleaner comprises more than 96 wt. % of the aqueous cleaning composition. In some embodiments, the cleaner comprises more than 98 wt. % of the aqueous cleaning composition.

The additional ingredients may be selected from the group consisting of surfactant, chelating agent, alkaline ingredient, fragrance, salt, emulsifier, degreasing agent, essential oil, colorant, solvent, corrosion inhibitor.

Under some embodiments, the cleaner consists of six ingredients: alkyl polyglycoside, an organic solvent comprising a diol, an alpha-hydroxy acid, a humectant, water, and fragrance.

Fragrance refers to odoriferous material that is able to provide a desirable smell to the cleaner itself or to the substrate exposed to the cleaner. The fragrances are generally in the liquid state of solid state at ambient temperature. Fragrance materials include, such materials as aldehydes, ketones, esters and the like that are conventionally employed to impart a pleasing fragrance to cleaning compositions. Naturally occurring plant and animal oils are also commonly used as components of fragrances.

The amount of fragrance can be any desired amount depending on the preference of the user. In certain embodiments, the amount of fragrance is about 0.3 wt. % to about 1 wt. % of the cleaner.

Examples of fragrances which may be used include lavender oil, eau de lavender, orange & ginger fragrance, coconut & citrus fragrance, apricot oil, bay oil, calendula oil, Aztec marigold oil, lemongrass oil, rose oil, lime oil, white grapefruit oil, and lavender vanilla fragrance.

The present invention is also directed to the aqueous cleaning composition, wherein the cleaner is a floor cleaner, a multipurpose cleaner, a hard surface cleaner, an all-purpose cleaner, or a spray cleaner.

A floor cleaner is a cleaning composition that is applied to the surface of the floor in order to clean the floor. The floor cleaner is effective on floors that are sealed or otherwise impervious to liquid, such as a wood floor, a tile floor, a stone floor, a vinyl composite, and like. The reason for cleaning floor include preventing injuries due to tripping or slipping; beautifying the floor; removing stains and dirt; removing grit and sand which scratch and wear down the surface; removing allergens, such as dust; preventing wear to the surface; making the environment sanitary (e.g., in kitchens); and maintaining an optimum traction (e.g., dance floors).

The present invention is also directed to a method of cleaning a substrate comprising administering an effective amount of the cleaner to the substrate. The substrate is a surface in need of cleaning, such as the surface of a floor, a countertop, bathroom surfaces, surface of appliances (e.g., stoves, ranges, refrigerators, microwaves, barbeques), metal parts, building façade, toilet bowl surfaces, glass surfaces, and like.

The method of cleaning the substrate comprises administering the aqueous composition to the surface. The administration may be achieved by pouring or spraying an effective amount of the cleaner onto the surface. To cleaning the substrate, this step of administering the aqueous composition to the surface may be preceded or followed by additional steps.

For example, the method to clean the floor using a floor cleaner (e.g., squirt & mop) comprises the steps of (1) squirting the cleaner directed from the bottle onto the floor in a 1 m×1 m section, avoiding puddling; (2) using a well wrung-out mop, cleaning immediately with even strokes; (3) moving to next section of floor and repeating.

Under one embodiment, the method of cleaning countertops, cabinets, furniture, paneling, and other similar surfaces, comprises squirting the cleaner directly from the bottle onto a cloth, and wiping clean to reveal wood's natural beauty.

### Examples

The ingredients used in formulating the working examples of the present invention were obtained from commercial sources. Decyl glucoside (55%) was obtained as Plantaren 2000 N UP from BASF Personal Care Creations and Nutrition GmbH (Monheim am Rhein, Germany). Decyl glucoside (55%) is a 48 to 55 wt. % solution of decyl glucoside in water. Lactic acid (88%) is a 88 wt. % solution of lactic acid in water. Eau de Lavender SC, Orange & Ginger, and Pacific Breeze are fragrances.

Three exemplary compositions of the present invention formulated as a squirt & mop formulation are described in Table 1 (below).

TABLE 1

| | Example 1 | Example 2 | Example 3 |
|---|---|---|---|
| Ingredient | Wt. % | | |
| Decylglucoside (55%) | 10.000 | 10.000 | 10.000 |
| 1,3-Propanediol | 3.000 | 3.000 | 3.000 |
| Lactic Acid (88%) | 2.300 | 2.300 | 2.300 |
| Glycerin | 1.000 | 1,000 | 1.000 |
| Fragrance | 0.340 | 0.350 | 0.350 |
| Water | Q.S. | Q.S. | Q.S. |

Because the decylglucoside ingredient is a 55 wt. % decylglucoside, and the lactic acid ingredient is a 88 wt. % lactic acid, the compositions of Examples 1 to 3 contain 5.500 wt. % decylglucoside, 3.000 wt. % propanediol, 2.024 wt. % lactic acid, 1.000 wt. % glycerin, and 0.0340 or 0.350 wt. % fragrance.

Three exemplary compositions of the present invention formulated as a spray formulation are presented below in Table 2.

TABLE 2

| | Example 4 | Example 5 | Example 6 |
|---|---|---|---|
| Ingredient | Wt. % | | |
| Decylglucoside (55%) | 5.000 | 5.000 | 5.000 |
| 1,3-Propanediol | 1.500 | 1.500 | 1.500 |
| Lactic Acid (88%) | 1.150 | 1.150 | 1.150 |
| Glycerin | 0.500 | 0.500 | 0.500 |
| Fragrance | 0.238 | 0.210 | 0.245 |
| Water | Q.S. | Q.S. | Q.S. |

Because the decylglucoside ingredient is a 55 wt. % decylglucoside, and the lactic acid ingredient is a 88 wt. % lactic acid, the compositions of Examples 4 to 6 contain 2.750 wt. % decylglucoside, 1.500 wt. % propanediol, 1.012 wt. % lactic acid, 0.500 wt. % glycerin, and 0.210 or 0.238 or 0.245 wt. % fragrance.

The efficacy of the exemplary compositions was tested against commercially available consumer cleaning products (Comp. Ex. I and Comp. Ex. II). Comp. Ex. I is a squirt and mop hard floor formulation comprising about 1 wt. % solids, about 0.4 wt. % APG, about 0.4 wt. % glycerin, and other ingredients. Comp. Ex. II is a multi-surface concentrate comprising about 9 wt. % solids, 1.7 wt. % APG, and about 0.3 wt. % glycerin. Comp. Ex. III and Comp. Ex. IV are commercially available spray cleaners. Comp. Ex. V and Comp. VI are commercially available all-purpose antibacterial liquid cleaners. Comp. Ex. VII and Comp. Ex. VIII are all-purpose cleaners with a multi-action formula that provides a deeper clean.

The removal of soap scum was tested via validated laboratory procedures. About 2.5 g of the product is used, at 10 strokes. The results are described in Table 3 (below), wherein higher % EFF indicates better soap scum removal. The 95% confidence interval for each is about 13%.

TABLE 3

| Formula | % EFF |
|---|---|
| Example 1 | 32.95 |
| Example 4 | 21.31 |
| Comp. Ex. I | 2.06 |
| Comp. Ex. II | 4.18 |

The results in Table 3 (above) demonstrate that the compositions of Examples 1 and 4 are statistically better in removing soap scum from a substrate than comparative compositions, Comp. Ex. I and Comp. Ex. II.

Degreasing effectiveness was tested via validated laboratory procedures. About 2.5 g of the product is used, at 3 strokes. The results of these tests are described in Table 4 (below), wherein higher % EFF indicates better degreasing ability.

TABLE 4

| Formula | % EFF |
|---|---|
| Example 1 | 85.8 |
| Example 4 | 67.5 |
| Comp. Ex. I | 35.7 |
| Comp. Ex. II | 61.7 |

The results in Table 4 (above) illustrate that exemplary compositions of the present invention (Example 1 and Example 4) are statistically better in degreasing a substrate than a comparative composition, Comp. Ex. I. Example 1 is also statistically better in degreasing a substrate than Comp. Ex. II.

The removal of lime scale was tested via validated laboratory procedures. The results are listed in Table 5 (below).

TABLE 5

| Formula | % CaCO₃ Removed |
|---|---|
| Example 1 | 2.13 |
| Example 4 | 2.23 |
| Comp. Ex. III | 0.90 |
| Comp. Ex. IV | 0.56 |
| Comp. Ex. V | 0.17 |
| Comp. Ex. VI | 0.28 |
| Comp. Ex. VII | 0.17 |
| Comp. Ex. VIII | 0.18 |

The results in Table 5 (above) illustrate that the compositions of Examples 1 and 4 are statistically better in removing soap scum from a substrate. Further, these differences are sizeable, meaning that they are readily apparent to an average end-user.

A foam shaker test without oil was performed using validated procedures. The results are listed in Table 6.

TABLE 6

| | Foam Height (cm) | | | |
|---|---|---|---|---|
| Formula | Initial | 60 sec \| | 120 sec | 180 sec |
| Example 3 | 14.3 | 13.8 | 13.8 | 13.8 |
| Example 5 | 13.0 | 13.0 | 12.9 | 12.6 |
| Comp. Ex. I | 4.3 | 4.1 | 4.1 | 4.1 |
| Comp. Ex. II | 13.5 | 13.5 | 13.5 | 13.3 |

The results in Table 6 show that two exemplary compositions of the present invention (Example 3 and Example 5) provide significantly greater foaming than a similarly formulated comparative composition (Comp. Ex. I).

The foam shaker test was performed with oil using validated procedures. The results are listed in Table 7 (below).

TABLE 7

| | Foam Height (cm) | | | |
|---|---|---|---|---|
| Formula | Initial | 60 sec | 120 sec | 180sec |
| Example 3 | 16.3 | 16 | 15.8 | 15.5 |
| Example 5 | 14.8 | 14.8 | 14.8 | 14.5 |
| Comp. Ex. I | 1.6 | 1.6 | 1.6 | 1.6 |
| Comp. Ex. II | 15.3 | 14.8 | 14.8 | 14.5 |

The results in Table 7 (above) demonstrate that two exemplary compositions of the present invention (Example 3 and Example 5) provide significantly greater foaming than a similarly formulated comparative composition (Comp. Ex. I).

While the present invention has been described with reference to several embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention is to be determined from the claims appended hereto. Further, it will be apparent to those of skill in the art that numerous changes may be made in such details without departing from the spirit and the principles of the invention.

1. A hard-surface cleaning composition comprising
(a) an alkyl polyglycoside;
(b) an organic solvent comprising a diol having the formula: CₙH₂ₙ(OH)₂, wherein n=3 to 10 and mixtures thereof;
(c) an alpha hydroxy acid; and
(d) a humectant.

2. The hard-surface cleaning composition according to claim 1, comprising a C₈, a C₁₀, a C₁₂, a C₁₄, or a C₁₆ alkyl polyglycoside.

3. The hard-surface cleaning composition according to claim 1, comprising a C₁₀ alkyl polyglycoside.

4. The hard-surface cleaning composition according to claim 1, wherein the alkyl polyglycoside comprises a blend of a C₈₋₁₀ alkyl polyglycoside and a C₁₀₋₁₆ alkyl polyglycoside.

5. The hard-surface cleaning composition according to claim 1, wherein the composition comprises from about 1 wt. % to about 10 wt. % of a blend of a C₈₋₁₀ alkyl polyglycoside and a C₁₀₋₁₆ alkyl polyglycoside.

6. The hard-surface cleaning composition according to claim 1, wherein the composition comprises from about 2 wt. % to about 6 wt. % of a blend of a C₈₋₁₀ alkyl polyglycoside and a C₁₀₋₁₆ alkyl polyglycoside.

7. The hard-surface cleaning composition according to claim 1, comprising a blend of a C₈₋₁₀ alkyl polyglycoside and a C₁₀₋₁₆ alkyl polyglycoside.

8. The hard-surface cleaning composition according to claim 1, wherein the composition comprises from about 0.5 wt. % to about 10 wt. % of the diol.

9. The hard-surface cleaning composition according to claim 1, wherein the composition comprises from about 1 wt. % to about 4 wt. % of the diol.

10. The hard-surface cleaning composition according to claim 1, wherein the diol is selected from the group consisting of ethanediol, propanediol, butanediol, and mixtures thereof.

11. The hard-surface cleaning composition according to claim 1, wherein the diol is 1,3-propanediol.

12. The hard-surface cleaning composition according to claim 1, wherein the alpha hydroxy acid is selected from the group consisting of citric acid, glycolic acid, lactic acid, malic acid, tartaric acid, and mixtures thereof.

13. The hard-surface cleaning composition according to claim 1, wherein the alpha hydroxy acid has the formula R—CH(OH)—COOH, wherein R is H or a C₁₋₈ hydrocarbyl group.

14. The hard-surface cleaning composition according to claim 13, wherein the alpha-hydroxy acid is selected from the group consisting of glycolic acid, lactic acid, and mandelic acid, and mixtures thereof.

15. The hard-surface cleaning composition according to claim 1, wherein the composition comprises from about 0.5 wt. % to about 10 wt. % of the alpha hydroxy acid.

16. The hard-surface cleaning composition according to claim 1, wherein the humectant is selected from the group consisting of glycerin, polyethylene glycol, propylene glycol, and mixtures thereof.

17. The hard-surface cleaning composition according to claim 1, wherein the composition is in a form selected from: a spray; a wipe; and a bucket dilutable cleaner.

18. The hard-surface cleaning composition according to claim 1, further comprising a fragrance or a colorant.

19. A method of cleaning a hard surface comprising applying an effective amount of a hard-surface cleaning composition according to claim 1 to a surface in need thereof.

20. A cleaning product comprising at least about 90 wt. % of the hard-surface cleaning composition according to claim 1.
